(19) United States
(12) Patent Application Publication
(10) Pub. No.: US 2008/0043391 A1
(43) Pub. Date: Feb. 21, 2008

(54) TIMER RESET CIRCUIT FOR OVERCURRENT PROTECTION OF SWITCHING POWER AMPLIFIER

(75) Inventors: Shiah Siew WONG, Singapore (SG); Jing SUN, Singapore (SG)

Correspondence Address: GREENBLUM & BERNSTEIN, P.L.C., 1950 ROLAND CLARKE PLACE, RESTON, VA, 20191, US

(73) Assignees: MATSUSHITA ELECTRIC INDUSTRIAL CO., LTD., Osaka (JP); PANASONIC SEMICONDUCTOR ASIA PTE. LTD., Singapore (SG)

(21) Appl. No.: 11/465,152

(22) Filed: Aug. 17, 2006

(51) Int. Cl. H02H 3/00

(52) U.S. Cl. 361/59

(57) ABSTRACT

A smart overcurrent protection circuit is introduced. In case of successive current due to certain malfunctions flows in power transistor of a switching circuit a control signal is activated to stop power transistor switching. When overcurrent condition is no longer satisfied, the switching circuit is still able to return to normal operation.

### BACKGROUND OF THE INVENTION

The present invention relates to a protection circuit for a switching power amplifier or a switching regulator and, more particularly, to a protection circuit for protecting the output stage of a switching circuit from destruction due to overcurrent from or to the load.

Most of the audio power amplifiers in the market are based on Class AB amplifier. This architecture offers very good total harmonic distortion plus noise (THD+N) performance, with fairly low quiescent current. However, the Class AB push-pull amplifiers are very inefficient and can only achieve an efficiency of about 60%, which results in not only power loss, but also additional bulky heatsink attached to the power amplifiers.

One major advantage of Class D amplifiers is the efficiency, which could reach above 90%. The high efficiency is achieved by full signal swing at power transistors. A typical Class D amplifier circuit 100 in FIG. 1 includes pulse width modulator 101, level shifter and driver stage 103, first MOSFET switch M1 104, and second MOSFET switch M2 105. The application circuit in connection with first MOSFET switch M1 104 and second MOSFET switch M2 105 includes output filter 106, bootstrap capacitor C1 107, decoupling capacitor C2 108, and loudspeaker 110. After the input audio signal is received by pulse width modulator 101, PWM_OUT is generated, which is rectangular wave whose pulse width is proportional to the audio signal amplitude. PWM_OUT is split and fed through level shifter and driver stage 103, to first MOSFET switch M1 104 and second MOSFET switch M2 105 respectively. The full swing pulse width modulated signal OUTPUT is thus generated. By passing through output filter 106, the carrier frequency component is removed and the analog audio signal is retrieved. Loudspeaker 110 is driven by the retrieved analog audio signal to generate audio sound. Loudspeaker 110 can be a single loudspeaker or a set of loudspeakers.

In the actual usage of Class D amplifier circuit 100, output filter 106, decoupling capacitor C2 108, and loudspeaker 110 serve as external load to the Class D amplifier circuit 100. It is possible that due to external load misplacement, shorting to ground, shorting to a power supply or other reason, first MOSFET switch M1 104 or second MOSFET switch M2 105 or both are continuously in the on state. Excessive current flows in either first MOSFET switch M1 104 or second MOSFET switch M2 105 or both, which is likely to cause damage to the amplifier circuit. Therefore, a countermeasure has to be implemented to protect first MOSFET switch M1 104 from sourcing excessive current and protect second MOSFET switch M2 105 from sinking excessive current.

FIG. 2 shows a typical system for protecting Class D amplifier from overcurrent. Referring to FIG. 2, a first current detection resistor R1 115 used to detect the current magnitude flowing through first MOSFET switch M1 104 is placed between power supply and first MOSFET switch M1 104 in series. A second detection resistor R2 116 used to detect the current magnitude flowing through second MOSFET switch M2 105 is placed between ground and second MOSFET switch M2 105 in series. Voltage V1 140 is developed at one end of first current detection resistor R1 115 in opposition of the other end of first current detection resistor R1 115, power supply. Voltage V2 141 is developed at one end of second current detection resistor R2 116 in opposition of the other end of second current detection resistor R2 116, ground. With this circuit configuration, the current magnitude flowing in first MOSFET switch M1 104 is effectively measured by the voltage magnitude of V1 140 with reference to power supply voltage, and the current magnitude flowing in the second MOSFET switch M2 105 is effectively measured by the voltage magnitude of V2 141 with reference to ground. In FIG. 2, a first comparator 121, a second comparator 122 and an OR gate 123 are included so as to constitute a control path such that control signal SD is activated when either an overcurrent is detected by V1 140 or an overcurrent is detected by V2 141 or both. A timer 1 130 is placed between comparator 121 and OR gate 123, which prevents control signal SD from being activated by the switching current in first current detection resistor R1 115 during carrier pulse switching. A timer 2 131 is placed between comparator 122 and OR gate 123, which prevents control signal SD from being activated by the switching current in second current detection resistor R2 116 during carrier pulse switching. Subsequently the logic high control signal SD turns off first MOSFET switch M1 104 and second MOSFET switch M2 105. Overcurrent in Class D amplifier is stopped and destruction due to overcurrent is prevented thereafter.

One disadvantage of above conventional overcurrent protection circuit is that upon the activation of control signal SD in case of overcurrent, first MOSFET switch M1 104 and second MOSFET switch M2 105 are in off state even if the overcurrent condition is no longer satisfied, for example, load short is cleared. The circuit will not come back to normal operation unless the Class D circuit is reset externally.

To overcome this disadvantage, one method is to allow Class D circuit to return to normal operation without any external control as long as overcurrent condition is no longer satisfied.

### SUMMARY OF THE INVENTION

The purpose of this invention is to introduce a smart overcurrent protection circuit, in which after overcurrent control signal is activated, the Class D circuit is still able to return to normal operation automatically when overcurrent condition is no longer satisfied.

According to the present invention, an overcurrent protection circuit is incorporated with overcurrent detection resistors, comparators, OR gate, SR latch and timer circuits to stop MOSFET switches from switching in case of overcurrent and to allow Class D circuit to return to normal operation when overcurrent condition is cleared.

As in a typical PWM Class D system, a pulse width modulator converts input audio signal to high frequency PWM signal. After passing through the level shifter and driver stage, the PWM signal drives output MOSFET switches.

In case of load short to ground or load short to power supply or other malfunctions, large current flows in either first MOSFET switch or second MOSFET switch or both. A first current detection resistor is placed between power supply and first MOSFET switch in series. A second current detection resistor is placed between ground and second MOSFET switch in series. Therefore, the current flowing through first MOSFET switch is detected by the voltage at the end of first current detection resistor with reference to power supply voltage. The current flowing through second MOSFET switch is detected by the voltage at the end of second current detection resistor with reference to ground.

The two developed voltages are then compared with two reference voltages respectively to determine whether current flowing through either MOSFET switch is higher than a predetermined level.

When the current flowing in either MOSFET switch is higher than a predetermined level, control signal is activated. The two MOSFET switches subsequently stop switching.

A timer circuit and SR latch deactivates the control signal after control signal is activated for a predetermined time period.

After the control signal is deactivated, MOSFET switches starts switching.

If the overcurrent condition is no longer satisfied, the Class D amplifier returns to normal operation.

If the overcurrent condition still exists, control signal is activated again to stop MOSFET switches from switching.

According to the present invention, a method for allowing Class D circuit to return to normal operation automatically when overcurrent condition is no longer satisfied comprising:

generating a logic high control signal when either the current flowing through first MOSFET switch is higher than a reference level or the current flowing through second MOSFET switch is higher than a reference level or both; and

generating a logic high reset signal to deactivate control signal after the control signal is activated for a predetermined time period.

According to the present invention, an apparatus for allowing Class D circuit to return to normal operation automatically when overcurrent condition is no longer satisfied comprising:

a SR latch operative to output a logic high signal if OR gate outputs a logic high signal; and

a timer circuit operative to output a logic high signal after the logic high signal at the input of this timer circuit lasts for a predetermined time period.

### BRIEF DESCRIPTION OF THE DRAWINGS

FIG. 1 is a block diagram showing the typical Class D system according to the prior art;

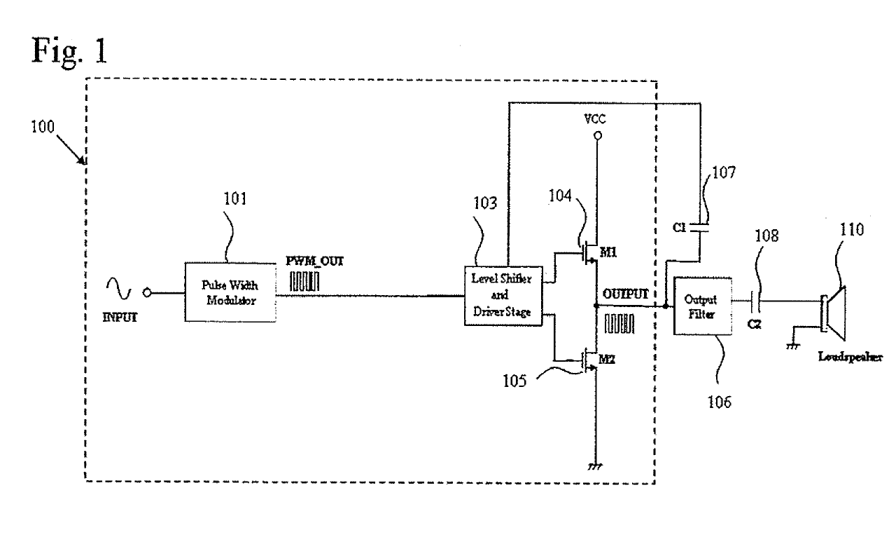

FIG. 2 is a block diagram showing the typical Class D system and overcurrent protection circuit according to the prior art;

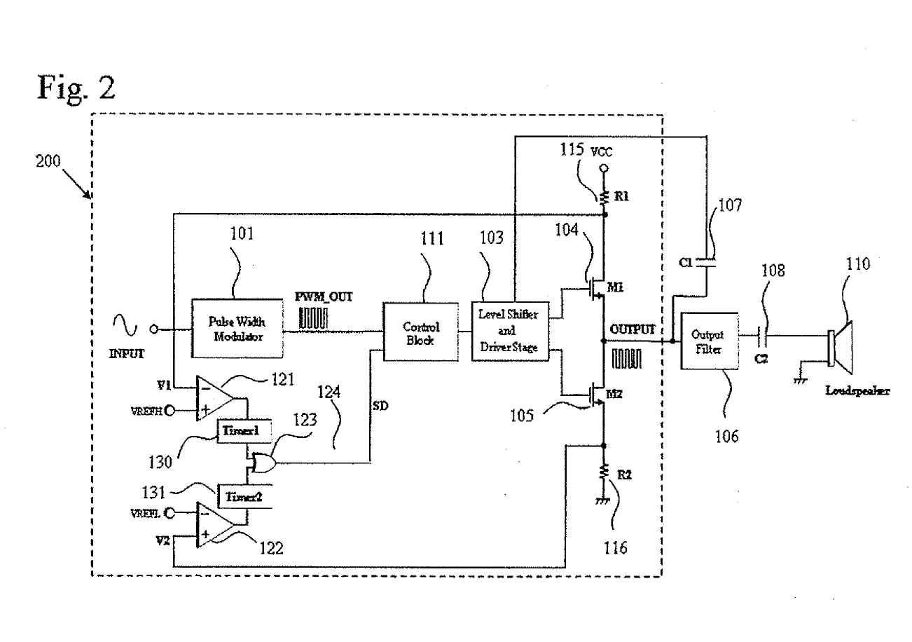

FIG. 3 is a block diagram showing the typical Class D system and overcurrent protection circuit with timer reset circuit according to the embodiment;

It will be recognized that some or all of the Figures are schematic representations for purposes of illustration and do not necessarily depict the actual relative sizes or locations of the elements shown.

### DETAILED DESCRIPTION OF THE PREFERRED EMBODIMENTS

The following description explains the best mode embodiment of the present invention.

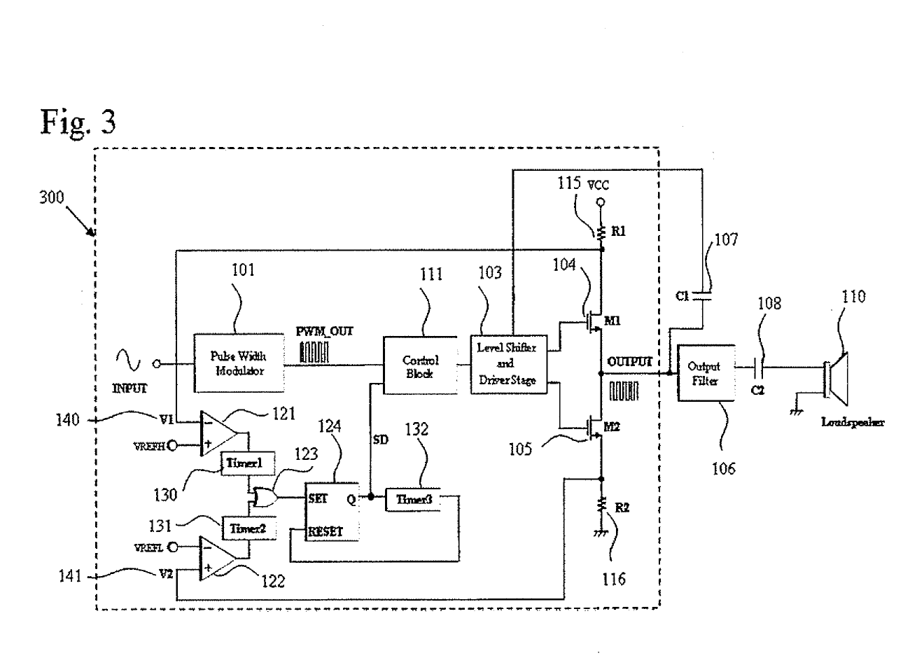

Referring to FIG. 3, a typical Class D system and overcurrent protection circuit with timer reset circuit according to the present invention is shown.

A typical Class D system has a pulse width modulator 101, a level shifter and driver stage 103, a first MOSFET switch M1 104, a second MOSFET switch M2 105. The overcurrent protection circuit with timer reset circuit has a first current detection resistor R1 115, a second current detection resistor R2 116, a first comparator 121, a second comparator 122, a timer 1 circuit 130, a timer 2 circuit 131, an OR gate 123, a SR latch 124, a control block 111 and a timer 3 circuit 132.

Here a first MOSFET switch M1 104 and a second MOSFET switch M2 105 are used, but can be any other type, such as N-type DMOS transistors, bipolar power transistors.

In normal operation, there is neither load short to ground nor load short to power supply nor other malfunctions. OUTPUT is switching in a rectangular wave between power supply and ground. The voltage at the end of the first current detection resistor V1 140 is lower than reference voltage VREFH only for a period that is shorter than a predetermined time period determined by timer 1 circuit 130. The voltage at the end of the second current detection resistor V2 141 is higher than reference voltage VREFL only for a period that is shorter than a predetermined time period determined by timer 2 circuit 131. Therefore, the control signal SD maintains logic low. Control block 111 acts as a buffer for PWM_OUT signal. First MOSFET switch M1 104 and second MOSFET switch M2 105 switch as normal.

In case of load short to ground or load short to power supply or other malfunctions, large current flows in either first MOSFET switch M1 104 or second MOSFET switch M2 105 or both. When large current flows in first MOSFET switch M1 104, the voltage at the end of the first current detection resistor V1 140 is lower than reference voltage. A logic high is generated at the output of first comparator 121. If the duration of large current flowing in first MOSFET switch M1 104 is longer than a predetermined time period determined by timer 1 circuit 130, a logic high is generated at the output of timer 1 circuit 130. When large current flows in second MOSFET switch M2 105, the voltage at the end of the second current detection resistor V2 141 is higher than reference voltage VREFL. A logic high is generated at the output of second comparator 122. If the duration of large current flowing in second MOSFET switch M2 105 is longer than a predetermined time period determined by timer 2 circuit 131, a logic high is generated at the output of timer 2 circuit 131. When either a logic high is generated at the output of timer 1 circuit 130 or a logic high is generated at the output of timer 2 circuit 131 or both, a logic high is generated at the output of OR gate 123. SR latch 124 generates a logic high control signal SD, which subsequently stops signal switching at the output of control block 111. The logic high control signal SD is maintained for a predetermined time period determined by timer 3 circuit 132. When control signal SD is in logic high state for a predetermined period determined by timer 3 circuit 132, a logic high is generated at the output of timer 3 circuit 132. Subsequently, SR latch 124 is resetted. When SR latch 124 is resetted, SR latch 124 generates a logic low control signal SD, which subsequently allows PWM_OUT pass though control block 111 and enables signal switching at OUTPUT. In case that load short to ground or load short to power supply or other malfunctions still exists, large current flows in either first MOSFET switch M1 104 or second MOSFET switch M2 105 or both.

Overcurrent protection circuit with timer reset circuit functions again as above described. In case that load short to ground or load short to power supply or other malfunctions does not exist, the Class D circuit returns to normal operation automatically.

Having described the above embodiment of the invention, various alternations, modifications or improvement could be made by those skilled in the art. Such alternations, modifications or improvement are intended to be within the spirit and scope of this invention. The above description is by ways of example only, and is not intended as limiting. The invention is only limited as defined in the following claims.

What is claimed is:

1. A method for allowing a switching circuit which has stopped switching at the output stage of said switching circuit due to an overcurrent condition or overcurrent conditions, to return to normal operation, when said overcurrent condition or overcurrent conditions are no longer satisfied, the method comprising:
activating a control signal to stop signal switching at said output stage of said switching circuit upon sensing said overcurrent condition or said overcurrent conditions; and
starting a timer circuit upon detecting the activation of said control signal; and
generating a reset signal from said timer circuit after said control signal is activated for a predetermined time period, to deactivate said control signal.

2. The method according to claim 1, wherein said switching circuit is a switching amplifier or a switching regulator or a system that uses a switching circuit.

3. The method according to claim 2, wherein said switching amplifier is in single ended load configuration or in bridge tied load configuration.

4. The method according to claim 1, wherein said control signal is a digital signal or an analog signal or a signal of certain form that functions to imply an overcurrent condition or overcurrent conditions have been detected.

5. The method according to claim 1, wherein said control signal is activated by a SR latch.

6. The method according to claim 1, wherein said timer circuit is a delay circuit or a circuit that causes signal delay for said predetermined time period.

7. The method according to claim 1, wherein said reset signal is activated by said timer circuit.

8. The method according to claim 1, wherein said reset signal is a digital signal or an analog signal or a signal of certain form that functions to imply said control signal has been activated for said predetermined time period.

9. The method according to claim 1, wherein said predetermined time period is determined by said timer circuit.

10. An apparatus for allowing a switching circuit, which has stopped switching at the output stage of said switching circuit due to an overcurrent condition or overcurrent conditions, to return to normal operation, when said overcurrent condition or overcurrent conditions are no longer satisfied, the apparatus comprising:
a SR latch operative to activate a control signal to stop signal switching at said output stage of said switching circuit upon sensing said overcurrent condition or said overcurrent conditions; and
a timer circuit operative to activate a reset signal after said control signal is activated for a predetermined time period.

11. The apparatus according to claim 1 0, wherein said switching circuit is a switching amplifier or a switching regulator or or a system that uses a switching circuit.

12. The apparatus according to claim 11, wherein said switching amplifier is in single ended load configuration or in bridge tied load configuration.

13. The apparatus according to claim 10, wherein said control signal is a digital signal or an analog signal or a signal of certain form that functions to imply an overcurrent condition or overcurrent conditions have been detected.

14. The apparatus according to claim 10, wherein said timer circuit is a delay circuit or any similar circuit that causes signal delay for a deliberate pre-determined time period.

15. The apparatus according to claim 10, wherein said reset signal is activated by said timer circuit.

16. The apparatus according to claim 10, wherein said reset signal is a digital signal or an analog signal or a signal of certain form that functions to imply said control signal has been activated for said predetermined time period.

17. The apparatus according to claim 10, wherein said predetermined time period is determined by said timer circuit.
